(19) United States
(12) Patent Application Publication
(10) Pub. No.: US 2009/0318145 A1
(43) Pub. Date: Dec. 24, 2009

(54) PUSH MECHANISM FOR INFORMATION SERVICES IN IEEE 802.21 MEDIA INDEPENDENT HANDOVER

(75) Inventors: Guang Lu, Montreal (CA); Michelle Perras, Montreal (CA); Juan Carlos Zuniga, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/481,811

(22) Filed: Jun. 10, 2009

Related U.S. Application Data
(60) Provisional application No. 61/074,926, filed on Jun. 23, 2008.

(51) Int. Cl. H04W 36/00

(52) U.S. Cl. 455/434

(57) ABSTRACT

A push mechanism for IEEE 802.21 media independent handover (MIH) information services (IS) is provided to push information to MIH users. Alternatively, an indication may be provided that information is available, and a pull mechanism may then be implemented to retrieve the information.

### CROSS REFERENCE TO RELATED APPLICATIONS

This application claims the benefit of U.S. Provisional Application No. 61/074,926 filed Jun. 23, 2008, which is incorporated by reference as if fully set forth.

### FIELD OF INVENTION

This application is related to wireless communications.

### BACKGROUND

The IEEE 802.21 media independent handover (MIH) standard defines mechanisms and procedures that aid in the execution and management of inter-access technology mobility management. The IEEE 802.21 standard defines three main services available to mobility management applications. FIG. 1 shows an IEEE 802.21 protocol architecture that uses such services, including an event service 100, an information service 105 and a command service 110. The services 100, 105 and 110 aid in the management of handover operations, system discovery and system selection by providing information and triggers from lower layers 115 to upper layers 120, and providing lower layer commands from the upper layers 120 to the lower layers 115 via a media independent handover function (MIHF) unit 125. While FIG. 1 shows the MIHF unit 125 as a middle layer in a protocol stack, the MIHF unit 125 may also be implemented as an MIH plane that is capable of exchanging information and triggers directly with each and every layer of a technology specific protocol stack.

Events may indicate changes in state and transmission behavior of physical, data link and logical link layers, or predict state changes of these layers. The event service 100 may also be used to indicate management actions or command status on the part of the network or a management entity. The command service 110 enables higher layers to control the physical, data link, and logical link layers, (referred to collectively as lower layers 115). The upper layers 120 may control the reconfiguration or selection of an appropriate link through a set of handover commands. If the MIHF unit 125 supports the command service, all MIH commands are mandatory in nature. When the MIHF 125 receives a command, it is always expected to execute the command. The information service 105 provides a framework and corresponding mechanisms by which a MIHF unit 125 may discover and obtain network information existing within a geographical area to facilitate handover. The information service 105 primarily provides a set of information elements (IEs), the information structure and its representation, and a query/response type of mechanism for information transfer.

Referring to FIG. 2, the third generation partnership project (3GPP) defines the features of an access network discovery and selection function (ANDSF) unit 200, which contains data management and control functionality necessary for network discovery and selection. Reference point 205 defines a link between a wireless transmit/receive unit (WTRU) 210 and the ANDSF unit 200 for direct queries via a pull mechanism. This enables dynamic provision of information to the WTRU 210 for network discovery and selection procedures related to non-3GPP access technologies. Push and/or combination of pull-push may be supported as well.

Referring to FIG. 3A, the current pull method configures an MIH server 305 in a “passive” manner to respond to an information request 315 received from an MIH client 310. The MIH server 305 provides information service 105 to the MIH client 310 via a unicast response message 320. The MIH client 310 discovers and obtains network information within a geographical area to facilitate network selection and handovers, (e.g., while connected on cellular network, the MIH client may request information about the availability of worldwide interoperability for microwave access (WiMAX) neighbors). If the MIH server 305 does not report any WiMAX neighbors in the geographical area, then the MIH client 310 will not scan for WiMAX and battery power will be saved. However, since the MIH server 305 has no mechanism to push some information to the MIH client 310, there is a need for a mechanism to provide bi-directional information request and response commands between the MIH server 305 and the MIH client 310 such that MIH service information can be pushed to the MIH client 310.

Referring to FIG. 3B, the MIH server 305 pushes information via an MIH_Push_Information_Indication message 315, but does not receive any feedback (confirmation), that indicates whether the pushed information was successfully received by the MIH client.

### SUMMARY

A push mechanism for IEEE 802.21 MIH information services (IS) is provided to push information to MIH users. Alternatively, an indication may be provided that information is available, and a pull mechanism may then be implemented to retrieve the information.

### BRIEF DESCRIPTION OF THE DRAWINGS

A more detailed understanding may be had from the following description, given by way of example in conjunction with the accompanying drawings wherein:

FIG. 1 shows a conventional IEEE 802.21 protocol architecture;

FIG. 2 shows a conventional WTRU to ANDSF link;

FIG. 3A shows a conventional MIH server lacking push capabilities;

FIG. 3B shows a conventional MIH server having push capabilities;

FIG. 4 shows a local MIH information service push mechanism.

FIG. 5 shows a local and remote MIH information service push mechanism;

FIG. 6 shows an alternate local MIH information service push mechanism;

FIG. 7 shows an alternate local and remote MIH information service push mechanism; and

FIG. 8 shows a block diagram of a WTRU used by a local MIH user.

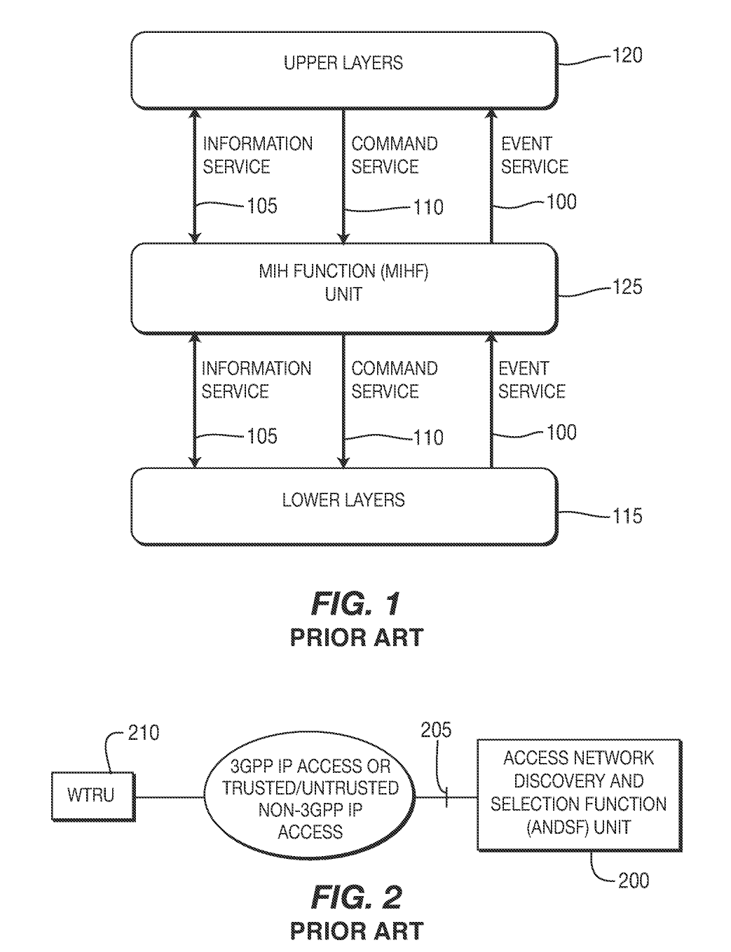

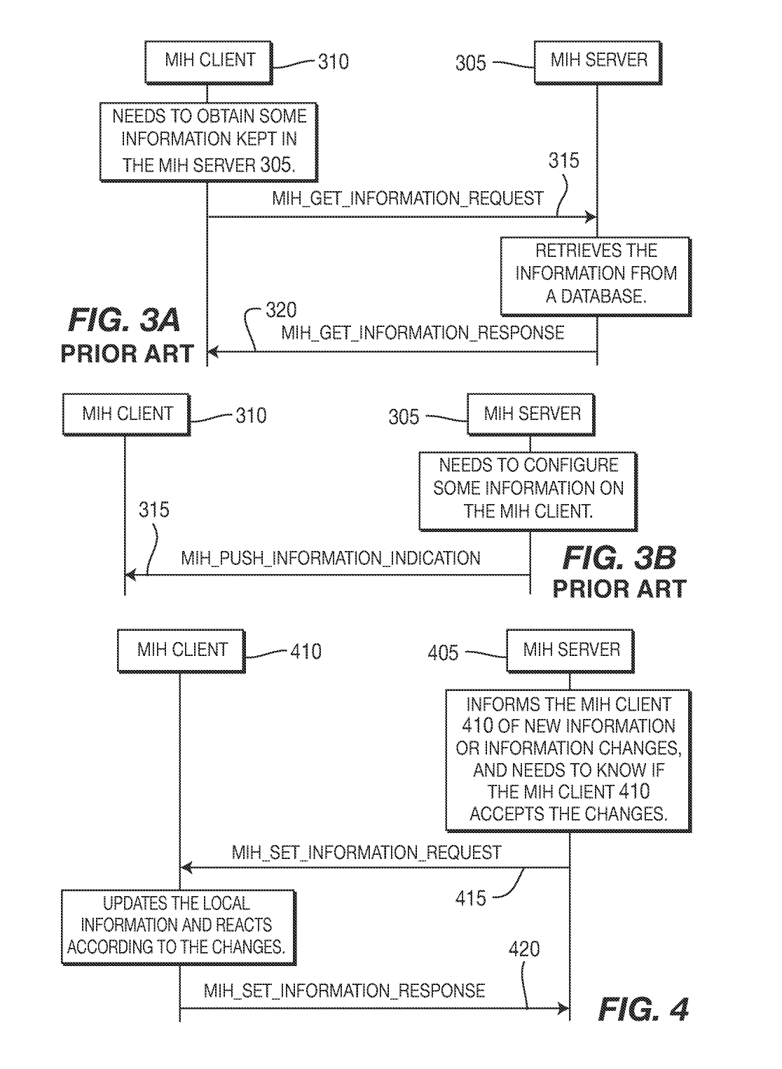

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment.

When referred to hereafter, the terminology “base station” includes but is not limited to a Node-B, a site controller, an access point (AP), or any other type of interfacing device capable of operating in a wireless environment.

FIG. 4 shows a local MIH information service push mechanism. Referring to FIG. 4, an MIH server 405 sends information to an MIH client 410 in a MIH_Set_Information_Request message 415. An MIH_Set_Information_Response message 420 is issued by the MIH client 410 to the MIH server 405 in response. The MIH server 405 requires a response from the MIH client 410 to ensure that the information is processed by the MIH client 410. The MIH_Set_Information_Response message 420 optionally functions as a confirmation.

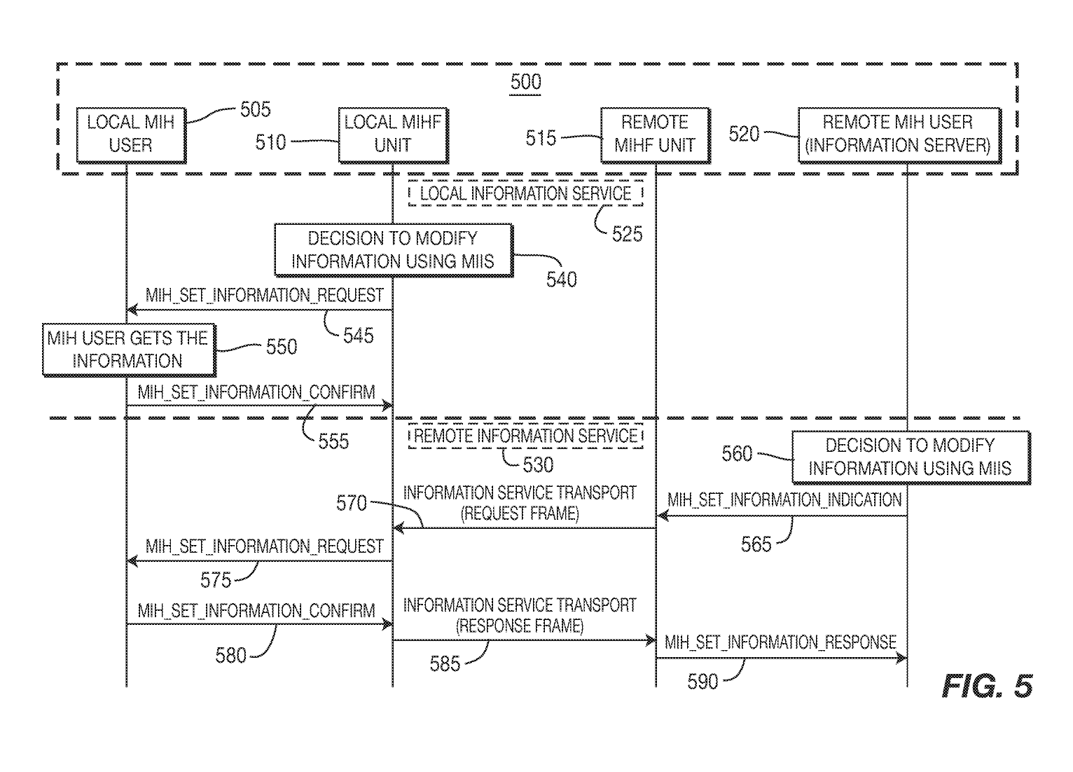

FIG. 5 shows a local and remote MIH information service push mechanism used in a wireless communication system 500, which includes a local MIH user 505, a local MIHF unit 510, a remote MIHF unit 515 and a remote MIH user (information server) 520. The dashed line in the middle of FIG. 5 separates two different use cases, which are indicated as local information service 525 and remote information service 530. An MIH server may have this capability or a separate media independent information services (MIIS) server may exist. The MIIS server is used to maintain location information, (e.g., existing neighbors in the network based on a current location). It may also be used to maintain a user's personal configuration, (e.g., a preferred network).

The local information service 525 represents the sequence of events when the local MIHF unit 510 desires to inform the local MIH user 505 of some information changes. Thus, the exchange of messages is local. The remote information service 530 represents changes in the information from the remote MIH user 520.

For the local information service 525, once the local MIHF unit 510 makes a decision to modify information using MIIS (step 540), the local MIHF unit 510 sends an MIH_Set_Information_Request message 545 to the local MIH user 505 to send MIH information to the local MIH user 505 when it has MIH information to distribute, such that the local MIH user gets the information (step 550). The local MIH user 505 then sends an MIH_Set_Information_Confirm message 555 to the local MIHF unit 510.

For the remote information service 530, once the remote MIH user 520 makes a decision to modify information using MIIS (step 560), the remote MIH user 520 sends an MIH_Set_Information_Indication message 565 to the remote MIHF unit 515. The remote MIHF unit 515 then sends an information service transport (request frame) message 570 to the local MIHF unit 510, which then forwards the MIH_Set_Information_Request message 575 to the local MIH user 505. The local MIH user 505 then sends an MIH_Set_Information_Confirm message 580 to the local MIHF unit 510, which then sends an information service transport (response frame) message 585 to the remote MIHF unit 515. The remote MIHF unit 515 then forwards the MIH_Set_Information_Response message 590 to the remote MIH user 520.

The MIH_Set_Information_Request message 545 and 575 is generated by the local MIHF unit 510. In the MIH_Set_Information_Request message 545 and 575, the order of the information elements (IEs) represent the order of preferences. The first IE is given a higher priority to be processed. In step 550, the local MIH user 505 receives and processes the information in the MIH_Set_Information_Request message 545, and sends an MIH_Set_Information_Confirm message 555 to the local MIHF unit 510.

The MIH_Set_Information_Confirm message 555 and 580 is generated by the local MIH user 505 to respond to a local MIH_Set_Information_Request message 545 and 575, respectively. The MIH_Set_Information_Confirm message 555 and 580 is generated by the local MIH user 505 as a confirmation that the information has been received and processed. If the MIH_Set_Information_Request message 545 and 575 comes from the local MIHF unit 510, an indication that the information has been received and processed may be recorded locally. If the MIH_Set_Information_Request message 575 comes from the remote MIHF 515, the confirmation may be forwarded in an MIH_Set_Information_Response message 590 to the remote MIH user 520.

The MIH_Set_Information_Indication message 565 carries the actual information. The MIH_Set_Information_Indication message 565 is generated by the remote MIH user (information server) 520 when it has information to send to the local MIH user 505.

The MIH_Set_Information_Response message 590 is used by the remote MIHF unit 515 to send a response to the remote MIH user (information server) 520. The MIH_Set_Information_Response message 590 is generated by the MIHF unit 515 in response to receiving the MIH_Set_Information_Indication message 565. The order of the IEs in the MIH_Set_Information_Response message 590 represent the order of preferences. Lower priority IEs may be omitted if the size of the MIH_Set_Information_Response message 590 exceeds a maximum size. The remote MIH user 520 will process the information in the MIH_Set_Information_Response message 590 and, if necessary, locally store an indication that the information has been received.

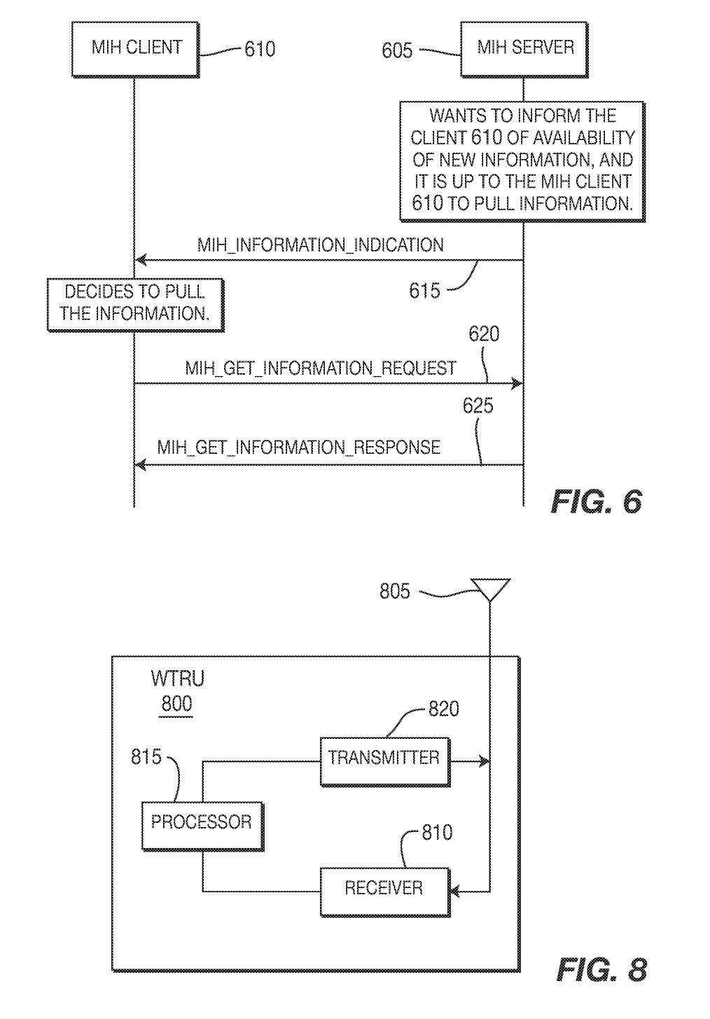

FIG. 6 shows an alternate local MIH information service push mechanism. Referring to FIG. 6, an MIH server 605 sends information to an MIH client 610 in a “light” MIH_Information_Indication message 615 to inform the MIH client 610 that information is available. The “light” MIH_Information_Indication message 615 indicates that some information is available. The available information is not actually contained in the message 615. The MIH client 610 may then decide to pull the information or not. This decision may be based on various parameters as desired. If the MIH client 610 decides to pull the information, it transmits an MIH_Get_Information_Request message 620. In response, the MIH server 605 transmits an MIH_Get_Information_Response message 625 to the MIH client 610 that includes the requested information.

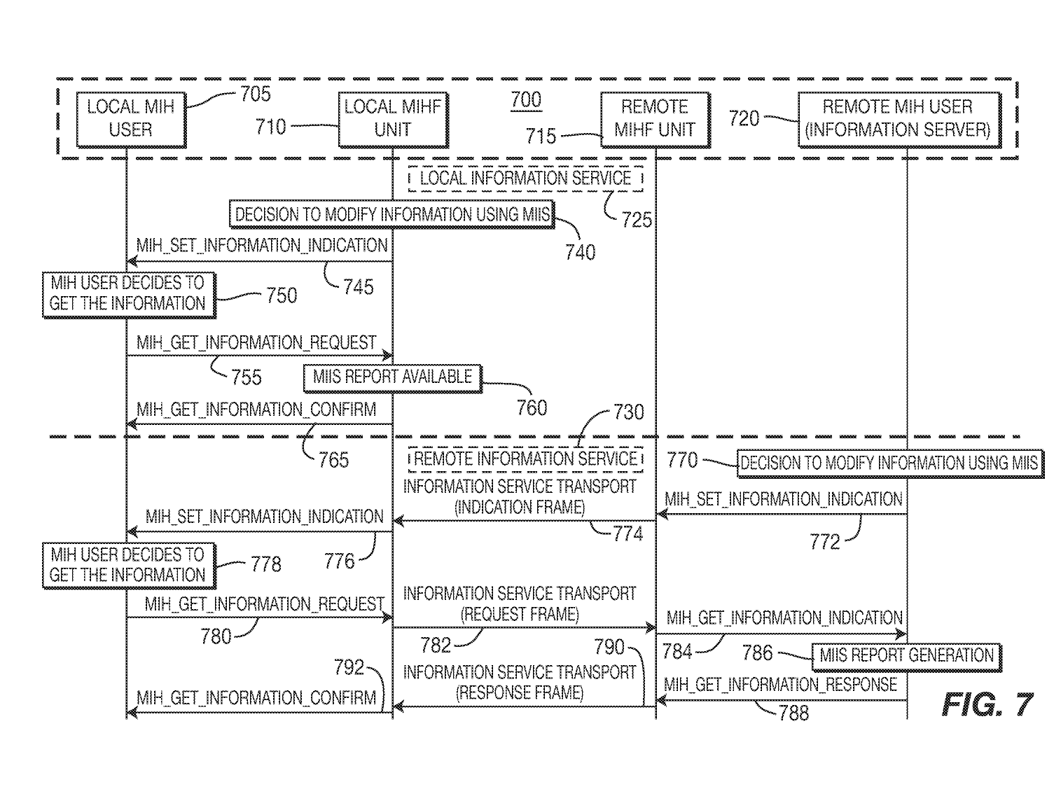

FIG. 7 shows an alternate local and remote MIH information service push mechanism used in a wireless communication system 700, which includes a local MIH user 705, a local MIHF unit 710, a remote MIHF unit 715 and a remote MIH user (information server) 720. The dashed line in the middle of FIG. 7 separates two different use cases, which are indicated as local information service 725 and remote information service 730.

The local information service 725 represents the sequence of events when the local MIHF unit 710 desires to inform the local MIH user 705 of some information changes. Thus, the exchange of messages is local. The remote information service 730 represents changes in the information for the remote MIH user 720.

For the local information service 725, once the local MIHF unit 710 makes a decision to modify information using MIIS (step 740), the local MIHF unit 710 sends an MIH_Set_Information_Indication message 745 to the local MIH user 705. If the local MIH user 705 decides to get the information (step 750), the local MIH user 705 sends an MIH_Get_Information_Request message 755 to the local MIHF unit 710. On a condition that the local MIHF unit 710 has information available (step 760), the local MIHF unit 710 sends an MIH_Get_Information_Confirm message 765 that includes the requested information to the local MIH user 705.

For the remote information service 730, once the remote MIH user 720 makes a decision to modify information using MIIS (step 770), the remote MIH user 720 sends an MIH_Set_Information_Indication message 772 to the remote MIHF unit 715. The remote MIHF unit 715 then sends an information service transport (indication frame) message 774 to the local MIHF unit 710, which then sends an MIH_Set_Information_Indication message 776 to the local MIH user 705. The local MIH user 505 then decides to get the information and sends an MIH_Get_Information_Request message 780 to the local MIHF unit 710, which then sends an information service transport (request frame) message 782 to the remote MIHF unit 715. The remote MIHF unit 715 then sends an MIH_Get_Information_Indication message 784 to the remote MIH user 720. The remote MIHF user then prepares the information (step 786) and sends an MIH_Get_Information_Response message 788 to the remote MIHF unit 715. The remote MIHF unit 715 then sends an information service transport (response frame) message 790 to the local MIHF unit 710, which then sends an MIH_Get_Information_Confirm message 792 to the local MIH user 705.

The MIH_Set_Information_Indication message 745 and 776 is generated by the local MIHF unit 710 to indicate that there is information available. To obtain the available information, the local MIH user sends an MIH_Get_Information_Request message 755 and 780 to request the available information. In response, the information is provided from the MIHF unit 710 via an MIH_Get Information_Confirm message 765 and 792.

As described above, the information service may exchange the following information: preferred network for an MIH user, changes in a network configuration, changes in a network map, and operators' policies. Of course, any information may be exchanged, as desired, and information that is typically exchanged using an MIH pull mechanism may be exchanged via the various push mechanisms disclosed herein.

The information services provided by IEEE 802.21 are increasingly useful for interworking between heterogeneous networks. Adding these new capabilities will further enhance the applicability of these services for present and future networks. Additionally, IEEE 802.21 information services are likely to be utilized by the ANDSF of 3GPP networks.

FIG. 8 shows a block diagram of a WTRU 800 used by either of the local MIH users 505 and 705 shown in FIGS. 5 and 7, respectively. The WTRU 800 includes an antenna 805, a receiver 810, a processor 815 and a transmitter 820.

The WTRU 800 is configured to obtain MIH information. The receiver 810 is configured to receive a first message indicating that MIH information is available for access. The processor 815 is configured to determine whether to pull the MIH information. The transmitter 820 is configured to transmit a second message requesting the MIH information indicated by the first message on a condition that it is determined to pull the MIH information. The receiver 810 is further configured to receive a third message including the MIH information. The transmitter 820 is further configured to transmit a message confirming receipt of the MIH information.

The WTRU 800 may also be configured to providing MIH information. The transmitter 820 is configured to transmit a first message indicating that MIH information is available for access. The receiver 810 is configured to receive a second message requesting the MIH information indicated by the first message. The transmitter 820 is further configured to transmit a third message including the MIH information.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method of obtaining media independent handover (MIH) information, the method comprising:
receiving a first message indicating that MIH information is available for access;
determining whether to pull the MIH information;
transmitting a second message requesting the MIH information indicated by the first message on a condition that it is determined to pull the MIH information; and
receiving a third message including the MIH information.

2. A wireless transmit/receive unit (WTRU) for obtaining media independent handover (MIH) information, the WTRU comprising:
a receiver configured to receive a first message indicating that MIH information is available for access;
a processor configured to determine whether to pull the MIH information;
a transmitter configured to transmit a second message requesting the MIH information indicated by the first message on a condition that it is determined to pull the MIH information; and
the receiver being further configured to receive a third message including the MIH information.

3. A method of providing media independent handover (MIH) information, the method comprising:
transmitting a first message indicating that MIH information is available for access;
receiving a second message requesting the MIH information indicated by the first message; and
transmitting a third message including the MIH information.

4. A wireless transmit/receive unit (WTRU) for providing media independent handover (MIH) information, the WTRU comprising:
a transmitter configured to transmit a first message indicating that MIH information is available for access;
a receiver configured to receive a second message requesting the MIH information indicated by the first message; and
the transmitter being further configured to transmit a third message including the MIH information.

5. A method of obtaining media independent handover (MIH) information, the method comprising:
receiving a first message including MIH information; and
transmitting a second message confirming receipt of the MIH information.

6. A wireless transmit/receive unit (WTRU) for obtaining media independent handover (MIH) information, the WTRU comprising:
a receiver configured to receive a first message including MIH information; and
a transmitter configured to transmit a second message confirming receipt of the MIH information.
